(19) United States
(12) Patent Application Publication
(10) Pub. No.: US 2016/0156217 A1
(43) Pub. Date: Jun. 2, 2016

(54) Wireless Charging System

(71) Applicant: Devon Pitts, Lithonia, GA (US)

(72) Inventor: Devon Pitts, Lithonia, GA (US)

(21) Appl. No.: 14/954,711

(22) Filed: Nov. 30, 2015

Related U.S. Application Data
(60) Provisional application No. 62/086,070, filed on Dec. 1, 2014.

(51) Int. Cl. H02J 7/02; H02J 7/00

(52) U.S. Cl. CPC H02J 7/025; H02J 7/0042

(57) ABSTRACT

A wireless charging system provides a protective case that protects a communication device, while simultaneously enabling the communication device to wirelessly receive charging from an inductive charging platform. The inductive charging platform receives power that induces an electromagnetic field to create and transmit power to the battery of the communication device inside the case. The case includes a pair of sidewalls and an inner surface that at least partially encapsulate the communication device. The case includes an inductive portion, a power supply portion, and a power transmission portion. An inductive charging platform wirelessly transmits power to the inductive portion to either charge or operate the communication device. The power transmission portion transmits power from the inductive portion to the battery of the communication device when the battery is at least partially depleted. The inductive charging platform comprises at least one ground portion for support and insulation.

### CROSS-REFERENCE TO RELATED APPLICATIONS

The present Utility patent application claims priority benefit of the U.S. provisional application for patent Ser. No. 62/086,070 entitled “ENERGY RUN”, filed on 1 Dec. 2014 under 35 U.S.C. 119(e). The contents of this related provisional application are incorporated herein by reference for all purposes to the extent that such subject matter is not inconsistent herewith or limiting hereof.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### FIELD OF THE INVENTION

One or more embodiments of the invention generally relate to a wireless charging system for a communication device. More particularly, the invention relates to a universal wireless charging system that wirelessly charges a wide variety of communication devices through inductive charging principles, while simultaneously providing protection to the communication device in a protective case.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that a cellular phone is a telephone that can make and receive calls over a radio-frequency carrier while a user is moving within the service area. Generally, the radio frequency link establishes a connection to the switching systems of a mobile phone operator, which provides access to the public switched telephone network.

Typically, phone cases serve to contain and protect a cellular phone. The cellular phone case is often mounted on the belt or simply carried in a pocket or purse. The cellular phone utilizes a battery for a power supply. When the battery runs out the power, the cellular phone is inoperative. To prevent the battery from running out of power, some phone cases carry additional batteries.

Typically, inductive charging is a form of wireless charging that uses an electromagnetic field to transfer energy between two objects. This is usually done with a charging station. Energy is sent through an inductive coupling to an electrical device, which can then use that energy to charge batteries or run the device.

It is known that induction chargers use an induction coil to create an alternating electromagnetic field from within a charging platform, and a second induction coil in the portable device takes power from the electromagnetic field and converts it back into electric current to charge the battery. The two induction coils in proximity combine to form an electrical transformer.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a perspective view of an exemplary wireless charging system for a communication device, showing an exemplary case partially encapsulating a communication device, and an inductive charging platform, in accordance with an embodiment of the present invention;

FIGS. 2A, 2B, and 2C illustrate views of an exemplary case, where FIG. 2A is a top view showing an inner surface of the case, FIG. 2B is a top view of an outer surface, and FIG. 2C is a perspective view of the case, in accordance with an embodiment of the present invention;

FIGS. 3A and 3B illustrate views of an exemplary power supply portion, where FIG. 3A is a rear view of the power supply portion joined with a renewable energy source, and FIG. 3B is a side view of the power supply portion joined with an exemplary inductive portion in the case, in accordance with an embodiment of the present invention;

FIGS. 4A and 4B illustrate top views of an exemplary case, where FIG. 4A is a top view showing an inner surface of the case, and FIG. 4B is a top view of an outer surface, in accordance with an embodiment of the present invention; and

FIGS. 5A, 5B, and 5C illustrate views of an exemplary inductive charging platform, where FIG. 5A is an elevated side view, FIG. 5B is a top view, and FIG. 5C is a bottom view, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, is well settle law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, term ‘substantially’ is well recognize in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. §112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” includes the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of, or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

### TERMINOLOGY

The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . . ” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. .sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” limits the scope of a claim to the specified elements or method steps, plus those that do not materially affect the basis and novel characteristic(s) of the claimed subject matter.

With respect to the terms “comprising,” “consisting of,” and “consisting essentially of,” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of.”

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

The present invention will now be described in detail with reference to embodiments thereof as illustrated in the accompanying drawings.

There are various types of covers and wireless chargers for communication devices that may be provided by preferred embodiments of the present invention. In one embodiment of the present invention, a universal wireless charging system is configured to wirelessly charge a communication device through inductive charging principles, while simultaneously providing protection to the communication device in a protective case. The charging means are integrated into the case, so as to enable simultaneous charging and protection for the communication device.

In some embodiments, the system may include an inductive portion, a power supply portion, and a power transmission portion that integrate into the case. An inductive charging platform wirelessly transmits electrical power to the inductive portion. The inductive portion serves as an inductive coupler for the inductive charging platform during this wireless inductive charging operation. The inductive portion may then transmit the power to a power transmission portion. The power transmission portion is configured to charge the power supply portion when a battery of the communication device is at least partially depleted.

The case is configured to at least partially encapsulate the communication device. In some embodiments, the case may include a pair of sidewalls having at least one aperture, an outer surface, and an inner surface. The aperture may be configured to enable access to at least one port and at least one switch on the communication device. The communication device may engage the inner surface, forming a snug fit within the case. In one embodiment, the case is adapted to at least partially encapsulate a variety of communication devices.

In one embodiment, the inductive portion may include an inductive charging coil that utilizes inductive principles to wirelessly receive power from a charging platform. Those skilled in the art will recognize that, these inductive charging principles enable universal charging of a wide variety of communication devices. In some embodiments, the charging platform, may be disposed separately from the case, and thereby the inductive portion. The charging platform may at least partially engage the case for transmitting power to the inductive portion. In one embodiment, the charging platform may include an induction type charge that generates an electromagnetic field to transfer the power to the inductive portion that is integrated in the case.

The power received by the inductive portion may be transferred to a power supply portion. The power supply portion may include, without limitation, a rechargeable battery. In one embodiment, a renewable energy source, such as a solar cell, may also be used to help supply power to the power supply portion.

In some embodiments, the power supply portion transmits the power to a power transmission portion. This transmission of power may be performed when the battery of the communication device is depleted. The power transmission portion may then transfer the power from the case to the battery in the communication device. In some embodiments, a power display portion may display the power level in the battery of the communication device, and/or the power level of the power supply portion of the case.

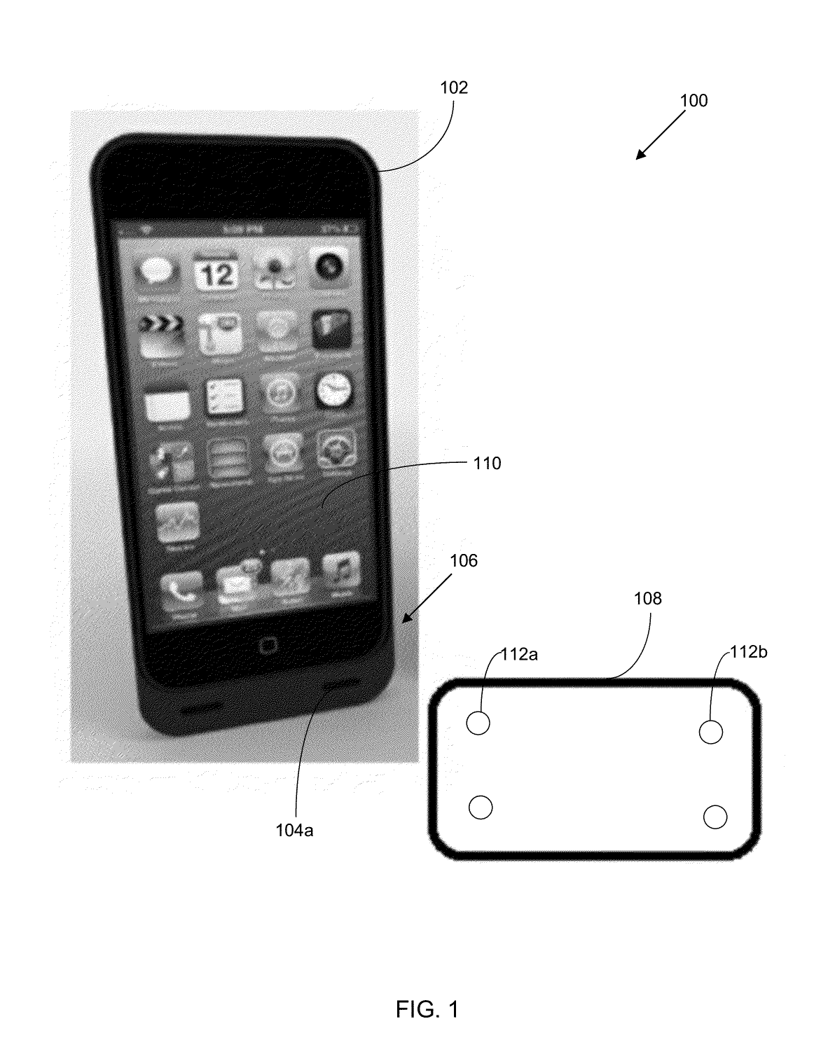

FIG. 1 illustrates a perspective view of an exemplary wireless charging system 100 for a communication device, showing an exemplary case 102 that partially encapsulates a communication device 110. FIG. 1 also illustrates an inductive charging platform 108 that transmits the power to the communication device through components in the case. In one aspect, a universal wireless charging system is configured to wirelessly charge a communication device through inductive charging principles, while simultaneously providing protection to the communication device in a protective case.

The charging means are integrated into the case, so as to enable simultaneous charging and protection for the communication device. While providing charging capacity, the case also provides protection and enables functionality for the communication device. For example, at least one aperture 104a, 104b, 104c in the case enables access to at least one port and at least one switch in the communication device.

In some embodiments, the case may include an inductive portion 106, a power supply portion, and a power transmission portion that integrate into the case. The inductive charging platform wirelessly transmits power to the inductive portion. The inductive portion serves as an inductive coupler for the inductive charging platform during this wireless inductive charging operation. The inductive portion may then transmit this power to the power transmission portion for charging the power supply portion, or operate the communication device. Specifically, the power transmission portion transmits power from the inductive portion to the battery of the communication device when the battery is at least partially depleted. In one embodiment, the inductive charging platform comprises at least one ground portion 112a, 112b for structural support and grounding insulation protection.

Those skilled in the art will recognize that inductive charging, or wireless charging as used in the present invention, uses an electromagnetic field to transfer power, such as electrical current, between two objects. This is usually done with a charging station. The power is sent through an inductive coupling to an electrical device, which can then use that energy to charge batteries or run the device.

Those skilled in the art will further recognize that an induction type charging station is often used. The charging station is often a platform that rests on a grounded supportive member. The charging platform generally has an induction coil. An outer power source provides power to the charging platform, so that when a connecting cable is plugged-in to provide the electric current to the charging platform, an electromagnetic field. The electromagnetic field works to wirelessly transfer power to the electronic devices. The present invention applies this inductive principle universally so as to be applicable with myriad types and sizes of communication devices.

The wireless charging system may especially be effective for increasing a communication device's battery life by up to 100%. Further, the case helps shield the device within its protective shell from drops, scratches, or other abrasions, and further adds the convenience of wireless charging. The system can be manufactured to fit eclectic communication devices including, without limitation, music players, cellular phones, and tablets. The system may also have myriad varieties of colors and designs.

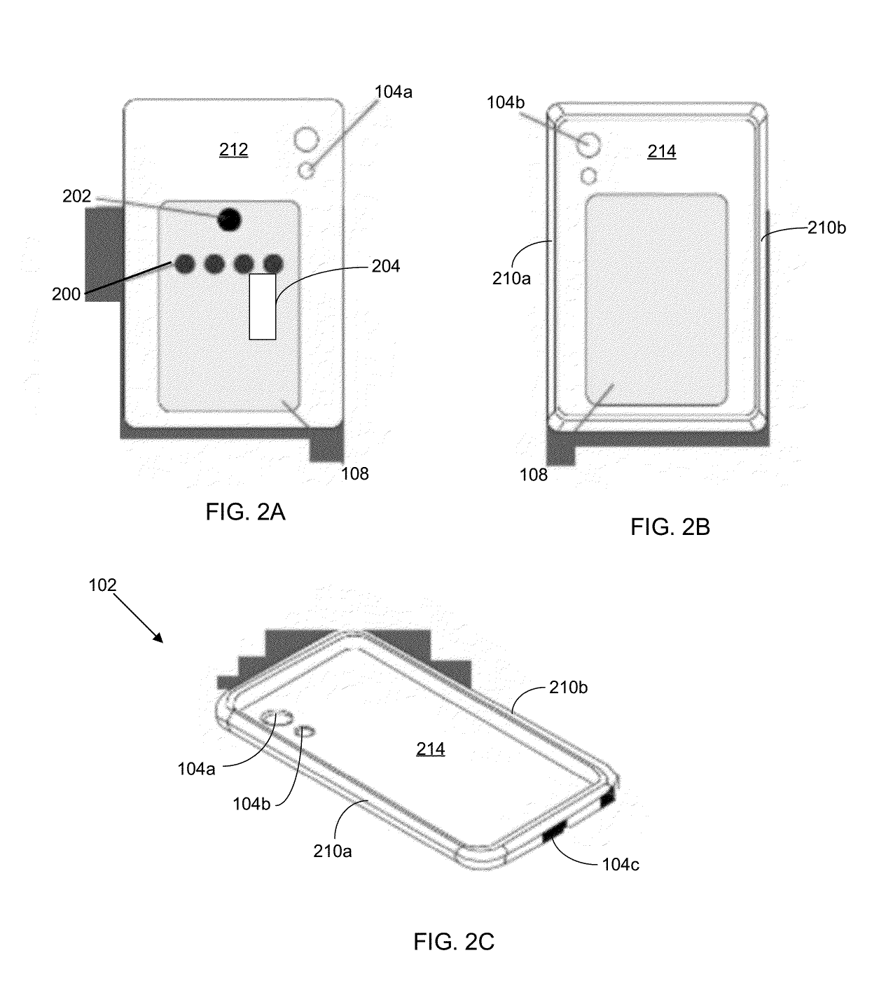

FIGS. 2A, 2B, and 2C illustrate views of an exemplary case, where FIG. 2A is a top view showing an inner surface of the case, FIG. 2B is a top view of an outer surface, and FIG. 2C is a perspective view of the case. In one aspect, the case is configured to at least partially encapsulate the communication device. In some embodiments, the case may include a pair of sidewalls 210a, 210b having at least one aperture, an outer surface 212, and an inner surface 214. The aperture may be configured to enable access to at least one port and at least one switch on the communication device.

In some embodiments, the communication device may engage the inner surface of the case, forming a snug fit within the case. In one embodiment, the case is adapted to at least partially encapsulate a variety of communication devices. For example, without limitation, a smart phone, a tablet, a radio, and a laptop.

In some embodiments, the case may integrated therein an inductive portion to directly receive power from the inductive charging platform. In one possible embodiment, the inductive portion may include an inductive charging coil that utilizes inductive principles to wirelessly receive power from a charging platform. These inductive charging principles enable universal charging of a wide variety of communication devices.

In some embodiments, the charging platform, may be disposed separately from the case, and thereby the inductive portion. The charging platform may at least partially engage the case for transmitting power to the inductive portion. In one embodiment, the charging platform may include an induction type charge that generates an electromagnetic field to transfer the power to the inductive portion in the case. The inductive platform may be sized to fit within the body of the case, such as in a flat, rectangular shape. Though other shapes may be possible. In one embodiment, the inductive portion is an electrical transformer coil.

The power received by the inductive portion may be transferred to a power supply portion 200. The power supply portion may include, without limitation, a rechargeable battery. A power display portion 202 may indicate the power level of the power supply portion, or of the power level in a battery of the communication device.

The power transmission portion 204 transmits the power from the inductive portion in the case to the battery in the communication device. The power transmission portion serves as a coupling mechanism between the inductive portion and the battery of the communication device. This transmission of power may be automatically actuated when the battery of the communication device is depleted.

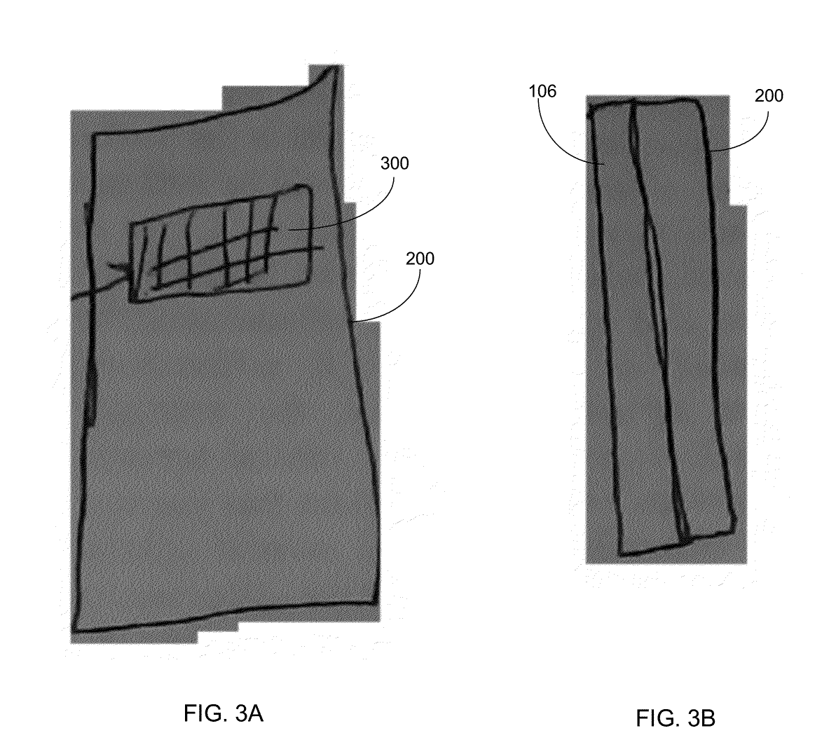

FIGS. 3A and 3B illustrate views of an exemplary power supply portion, where FIG. 3A is a rear view of the power supply portion joined with a renewable energy source, and FIG. 3B is a side view of the power supply portion joined with an exemplary inductive portion in the case. In one embodiment, the power supply portion is a rechargeable 2100 mAh Lithium-ion battery. Though, any type of rechargeable battery may be used. In one alternative embodiment, a renewable energy source 300, such as a solar cell, may also be used to help supply power to the power supply portion.

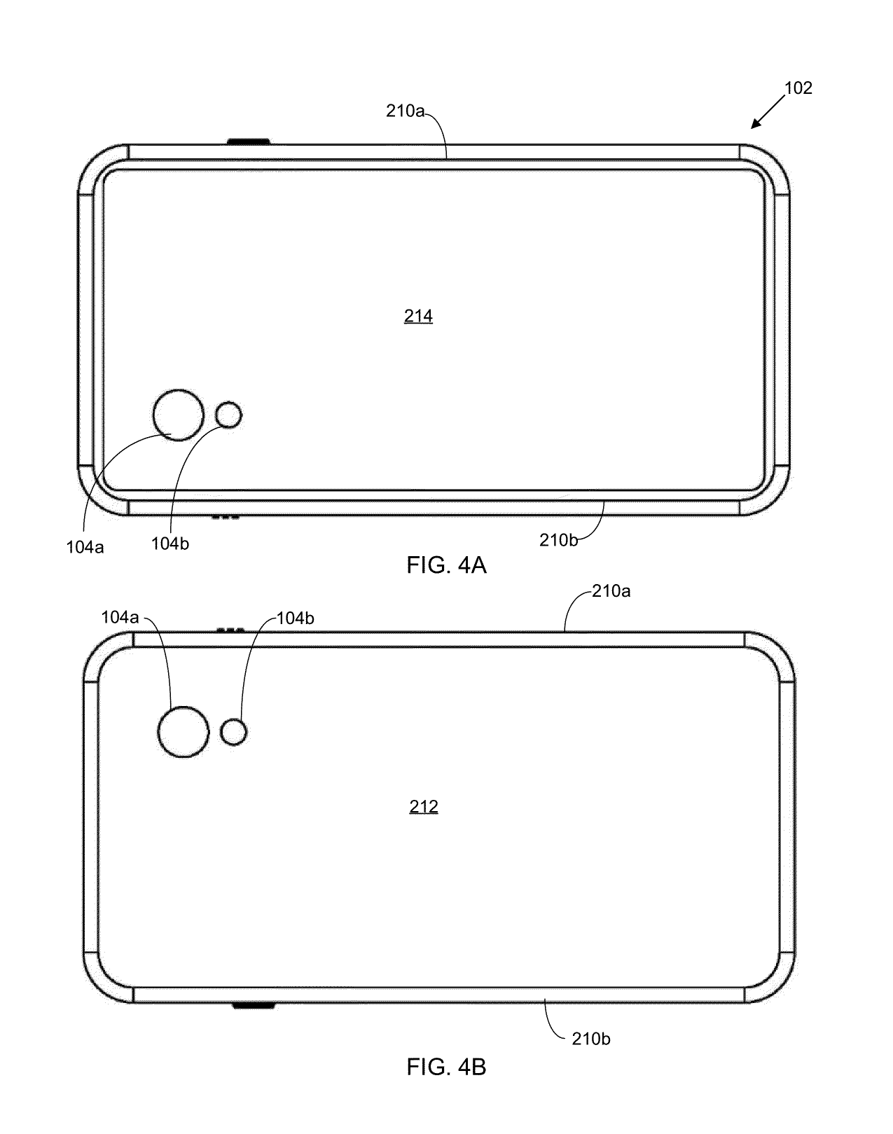

FIGS. 4A and 4B illustrate top views of an exemplary case, where FIG. 4A is a top view showing an inner surface of the case, and FIG. 4B is a top view of an outer surface. In one aspect, the power supply portion transmits the power to a power transmission portion. This transmission of power may be performed when the battery of the communication device is depleted. The power transmission portion may then transfer the power from the case to the battery in the communication device. In some embodiments, a power display portion may display the power level in the battery of the communication device, and/or the power level of the power supply portion of the case.

In some embodiments, the case may at least partially encapsulate the communication device, forming a snug fit. The case may be flexible, rigid, or semi-rigid. In some embodiments, the case may include a pair of sidewalls having at least one aperture, an outer surface, and an inner surface. The sidewalls may be pliable to enable passage of the communication device. Suitable materials for the case may include, without limitation, polyurethane, a flexible polymer, a rigid polymer, aluminum, a metal alloy, and wood.

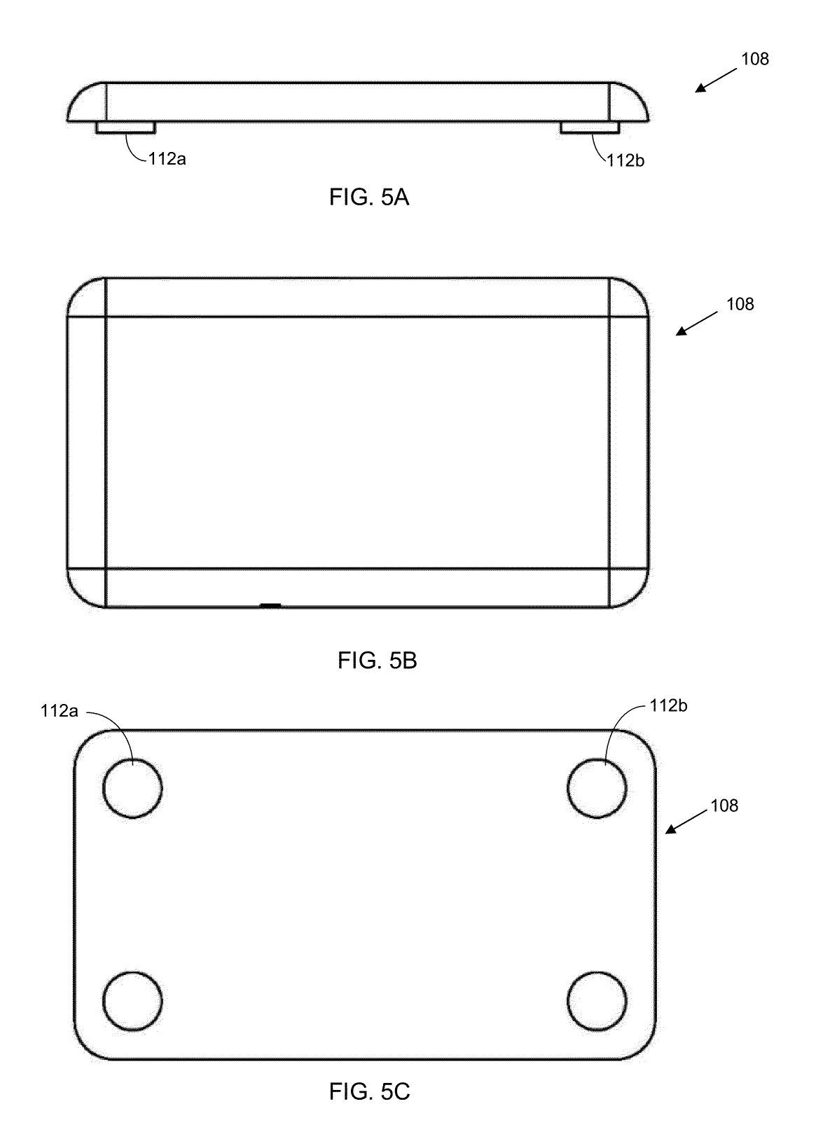

FIGS. 5A, 5B, and 5C illustrate views of an exemplary inductive charging platform, where FIG. 5A is an elevated side view, FIG. 5B is a top view, and FIG. 5C is a bottom view of the inductive charging platform. In one aspect, the inductive charging platform may be disposed separately from the case, and thereby the inductive portion. The charging platform may at least partially engage the case for transmitting power to the inductive portion. For example, the case may rest on the charging platform, with the inductive portion facing the charging platform. In one embodiment, the charging platform may include an induction type charge that generates an electromagnetic field to transfer the power to the inductive portion that is integrated in the case. The electromagnetic field may be adjustable to increase or decrease the charge, as required.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing a universal wireless charging system is configured to wirelessly charge a communication device through inductive charging principles, while simultaneously providing protection to the communication device in a protective case according to the present invention will be apparent to those skilled in the art. Various aspects of the invention have been described above by way of illustration, and the specific embodiments disclosed are not intended to limit the invention to the particular forms disclosed. The particular implementation of the universal wireless charging system is configured to wirelessly charge a communication device through inductive charging principles, while simultaneously providing protection to the communication device in a protective case may vary depending upon the particular context or application. By way of example, and not limitation, the universal wireless charging system is configured to wirelessly charge a communication device through inductive charging principles, while simultaneously providing protection to the communication device in a protective case described in the foregoing were principally directed to a protective case that wirelessly receives charging from an inductive charging platform that induces electromagnetic fields to create and transmit power to a communication device inside the case implementations; however, similar techniques may instead be applied to charging vehicle batteries, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A wireless charging system for helping to protect and charge a communication device, said system comprising:
a case, said case comprising a pair of sidewalls, an inner surface, an outer surface, and at least one aperture, said case being configured to enable at least partial encapsulation of a communication device;
an inductive charging platform, said inductive charging platform being configured to receive power, said inductive charging platform further being configured to generate an electromagnetic field from said power, said electromagnetic field being operable to induce inductive charging;
an inductive portion, said inductive portion being disposed to join with said case, said inductive portion being configured to enable at least partial engagement with said inductive charging platform, whereby said electromagnetic field is operable to enable at least partial transmission of said power from said inductive charging platform to said inductive portion;
a power supply portion, said power supply portion being disposed to operatively join with said inductive portion, said power supply portion being configured to receive said power from said inductive portion, said power supply portion further being configured to enable at least partial transmission of said power to a battery of said communication device;
a renewable energy source, said renewable energy source being configured to generate renewable power, said renewable energy further being configured to transmit at least a portion of said renewable power to said power supply portion; and
a power transmission portion, said power transmission portion being disposed to operatively join with said power supply portion, said power transmission portion being configured to receive power from said power supply portion, said power transmission portion further being disposed to operatively join with said battery of said communication device, said power transmission portion further being configured to enable transmission of said power and said renewable power to said battery of said communication device, when said battery is at least partially depleted.

2. The system of claim 1, wherein said system is configured to induce inductive charging.

3. The system of claim 2, wherein said case is configured to detachably encase said communication device.

4. The system of claim 3, wherein said case is fabricated of a pliable polymer.

5. The system of claim 4, wherein said at least one aperture is configured to enable access to at least one port and at least one switch in said communication device.

6. The system of claim 5, in which said communication device comprises a smart phone.

7. The system of claim 6, in which said inductive charging platform comprises at least one ground portion.

8. The system of claim 7, wherein said at least one ground portion is configured to at least partially support said inductive charging platform.

9. The system of claim 8, wherein said at least one ground portion is configured to at least partially ground said inductive charging platform.

10. The system of claim 9, in which said inductive portion comprises an inductive charging coil.

11. The system of claim 10, in which said power supply portion comprises an external battery pack.

12. The system of claim 11, in which said renewable energy source is a solar cell.

13. The system of claim 12, further including a circuit board.

14. The system of claim 13, wherein said circuit board is configured to electrically connect said renewable energy source to said power supply portion.

15. The system of claim 14, further including a power display portion.

16. The system of claim 15, wherein said power display portion is configured to display a power level of said power supply portion.

17. The system of claim 16, in which said power display portion comprises a plurality of light emitting diodes, said plurality of light emitting diodes being configured to correspond to a plurality of power levels.

18. The system of claim 17, wherein said power is electrical power.

19. A system comprising:
means for at least partially encapsulating communication means;
means for inducing an electromagnetic field through inductive charging;
means for transferring power through said electromagnetic field inducing means;
means for storing said power; and
means for charging a power supply means in said communication means with said stored power means.

20. A wireless charging system for helping to protect and charge a communication device, said system comprising:
a case, said case comprising a pair of sidewalls, an inner surface, an outer surface, and at least one aperture, said case being configured to enable at least partial encapsulation of a communication device;
an inductive charging platform, said inductive charging platform being configured to receive power, said inductive charging platform further being configured to generate an electromagnetic field from said power, said electromagnetic field being operable to induce inductive charging;
an inductive portion, said inductive portion being disposed to join with said case, said inductive portion being configured to enable at least partial engagement with said inductive charging platform, whereby said electromagnetic field is operable to enable at least partial transmission of said power from said inductive charging platform to said inductive portion;
a power supply portion, said power supply portion being disposed to operatively join with said inductive portion, said power supply portion being configured to receive said power from said inductive portion, said power supply portion further being configured to enable at least partial transmission of said power to a battery of said communication device;
a renewable energy source, said renewable energy source being configured to generate renewable power, said renewable energy further being configured to transmit at least a portion of said renewable power to said power supply portion;
a circuit board, said circuit board being configured to electrically connect said renewable energy source to said power supply portion;
a power transmission portion, said power transmission portion being disposed to operatively join with said power supply portion, said power transmission portion being configured to receive power from said power supply portion, said power transmission portion further being disposed to operatively join with said battery of said communication device, said power transmission portion further being configured to enable transmission of said power and said renewable power to said battery of said communication device, when said battery is at least partially depleted; and
a power display portion, said power display portion being configured to display a power level of the power supply portion.
